(19) United States
(12) Patent Application Publication
(10) Pub. No.: US 2007/0001057 A1
(43) Pub. Date: Jan. 4, 2007

(54) Tethered, pilotable, stationary/towable kite

(76) Inventors: Donald Charles Vincent, Prairieville, LA (US); Harold Paul Moore, New Orleans, LA (US)

Correspondence Address: Harold Paul Moore, 10 Yosemite Drive, New Orleans, LA, 70131-8620, US

(21) Appl. No.: 11/171,049

(22) Filed: Jul. 1, 2005

(51) Int. Cl. B64C 31/06

(52) U.S. Cl. 244/900; 244/153 R

(57) ABSTRACT

Disclosed is a device kite-like in nature which allows the user to ride within the kite and control its flight from within, rather than being a ground-based operator. Principle use of the invention is as a recreational device. The pilot/occupant is able to control pitch and yaw of the craft through conventional aircraft-like means and/or novel methods, and is also able to control winding and unwinding of the kite's tether from the cockpit. The device can be used stationary when there exists sufficient wind, in the manner of a kite, or the device may be towed by a ground-based vehicle (auto or boat) in the manner of a parasail.

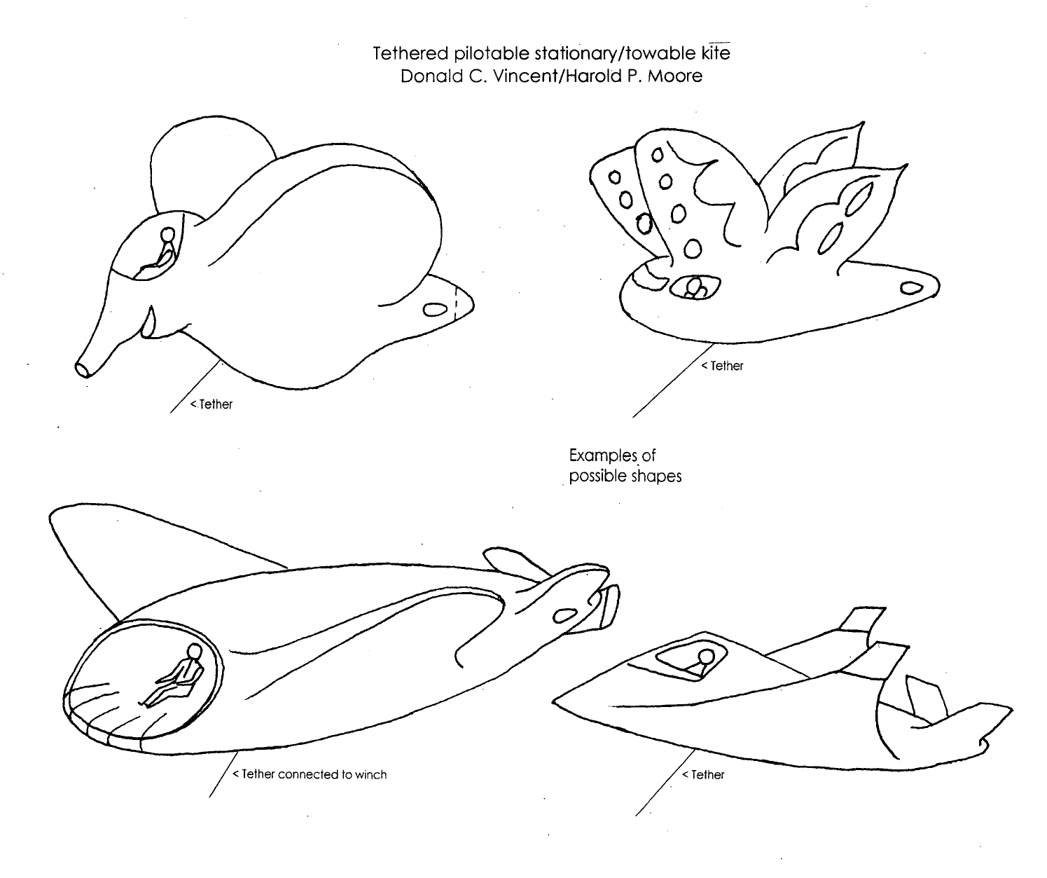

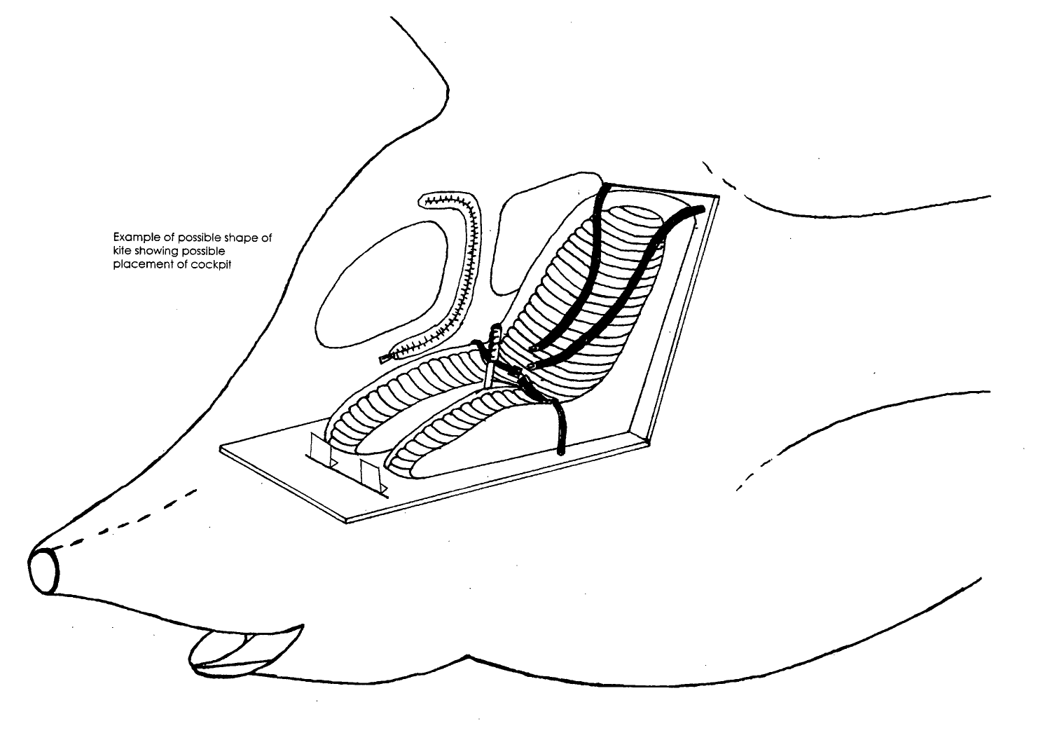

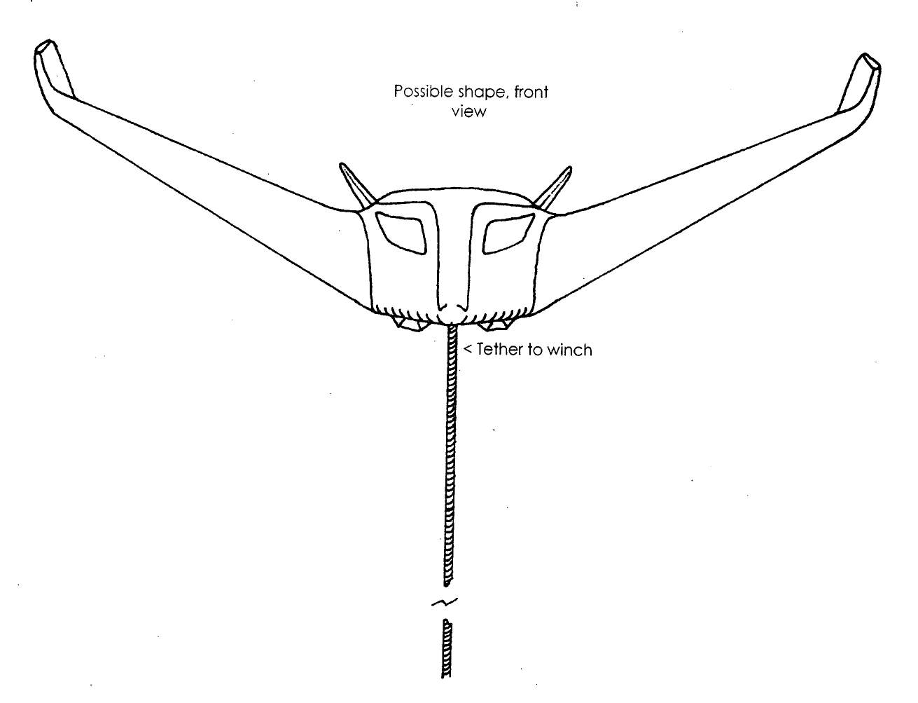

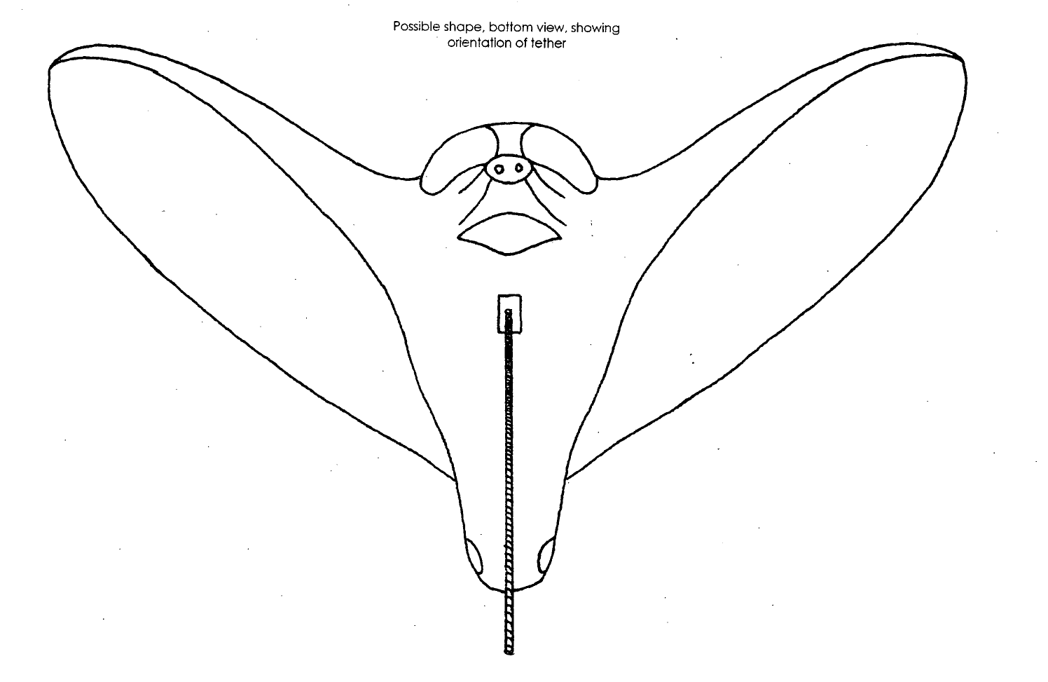

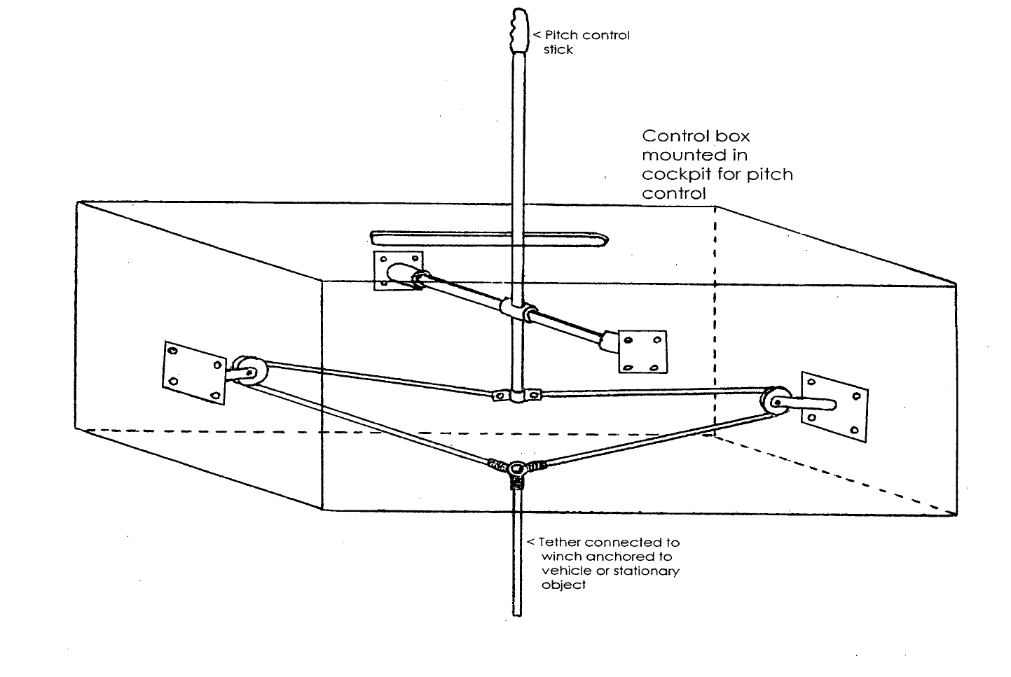

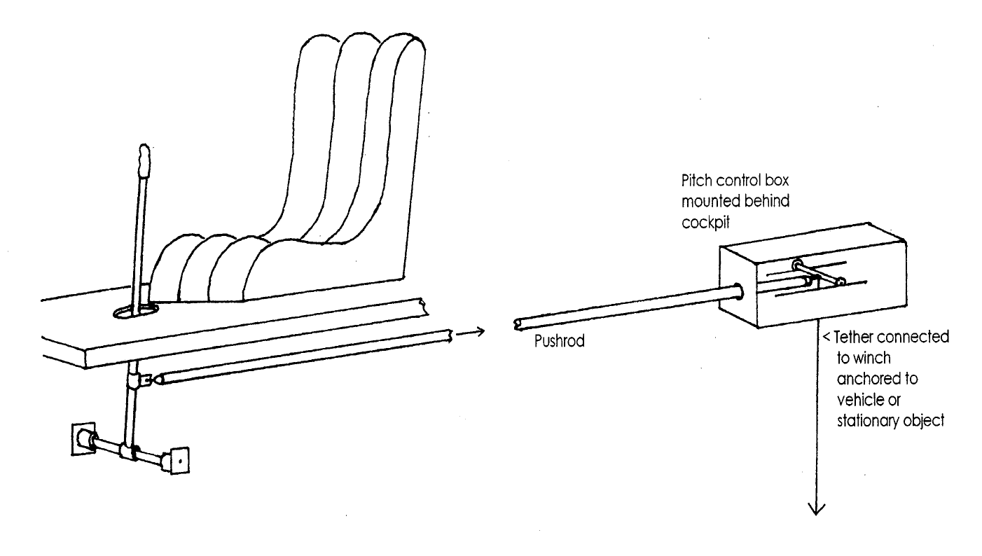

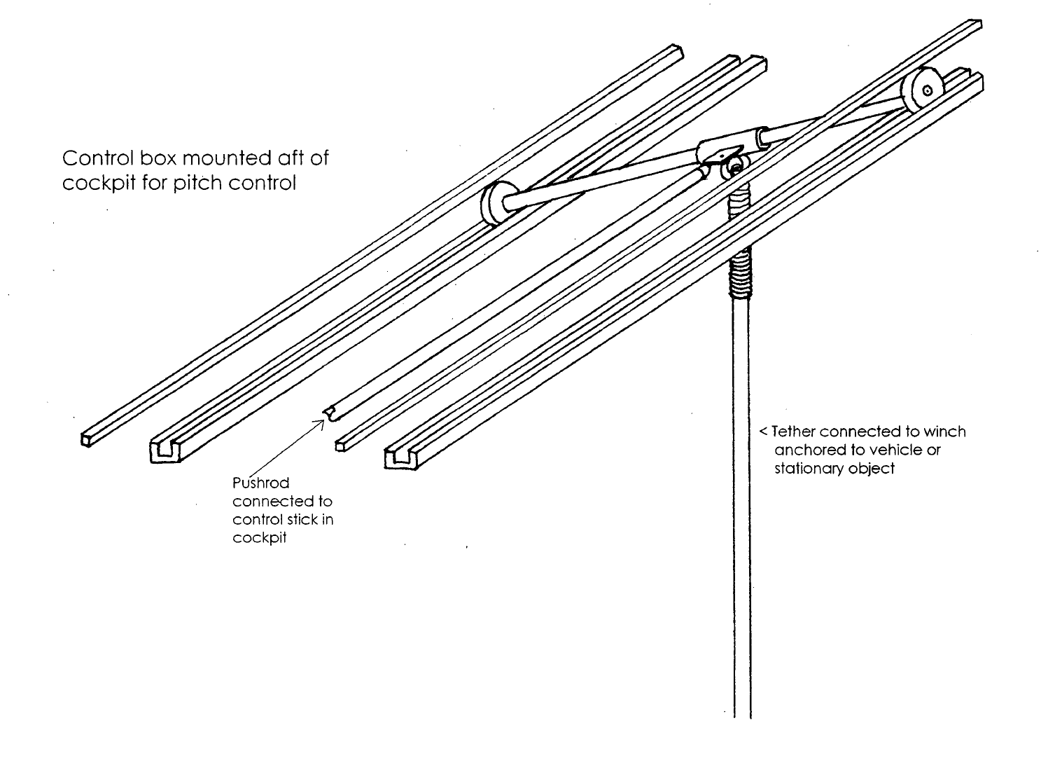

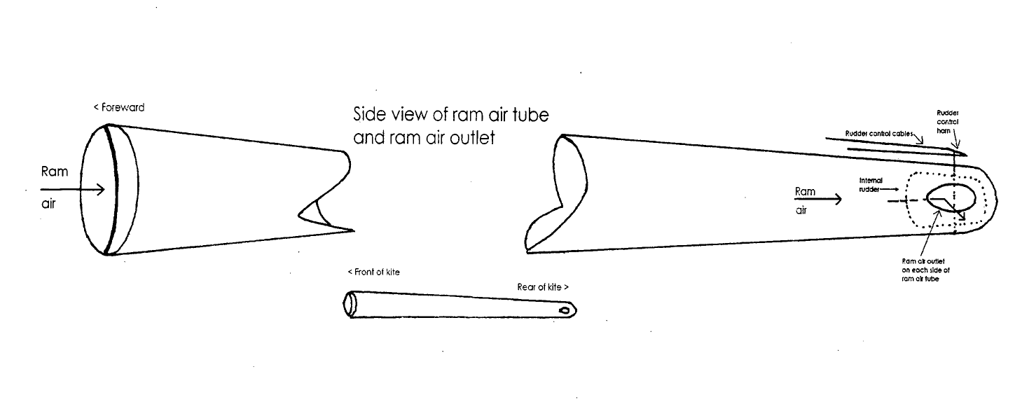

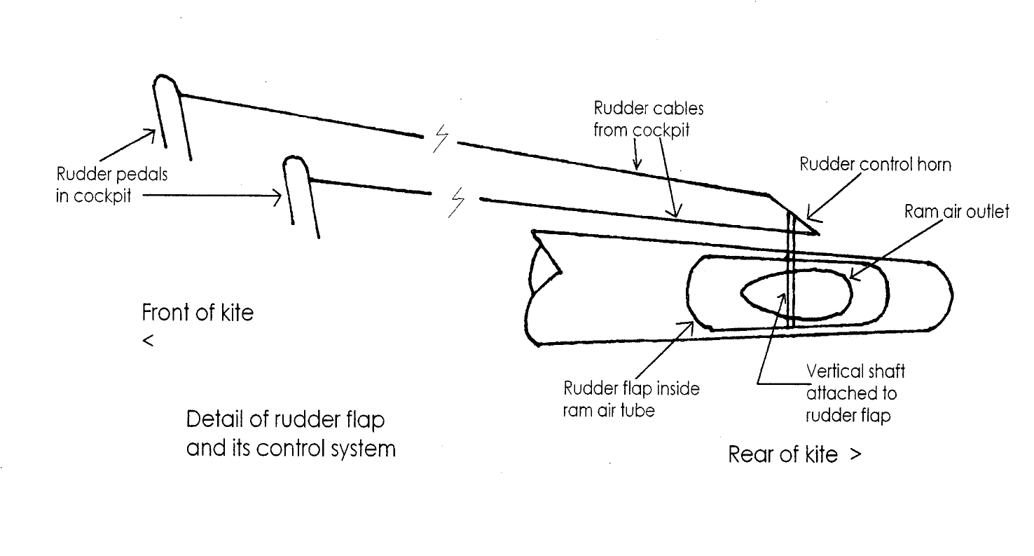

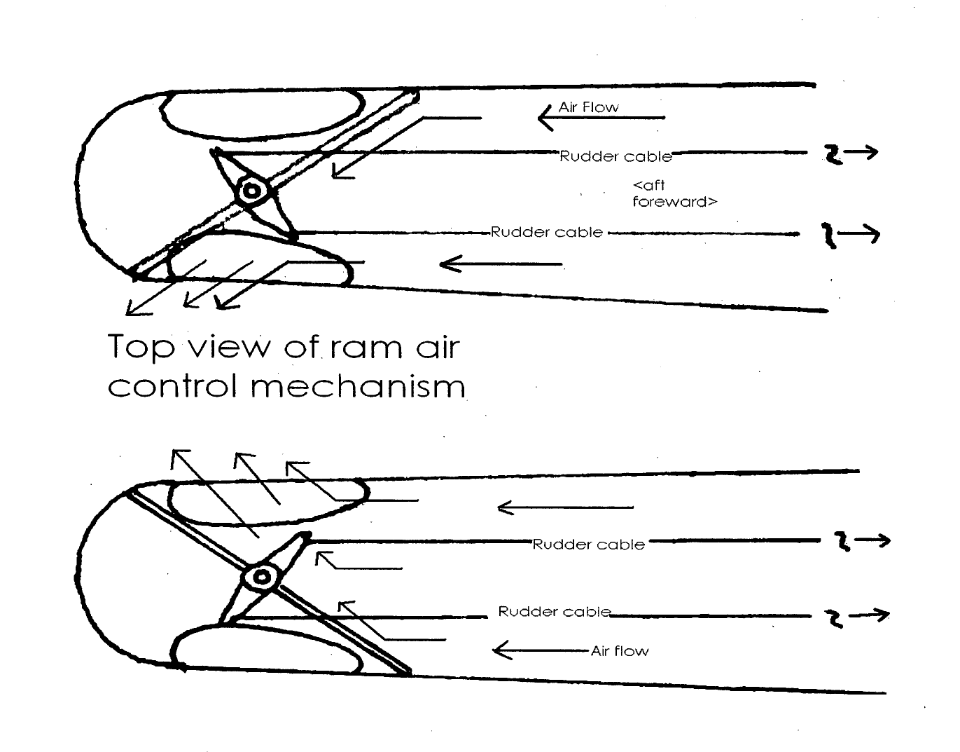

### CROSS REFERENCE TO RELATED APPLICATIONS

(none)

### STATEMENT REGARDING FEDERALLY SPONSORED RESEARCH OR DEVELOPMENT

The inventors of this device receive no federal funding of any kind in furtherance its research and development.

### REFERENCE TO SEQUENCE LISTING

(NONE)

### BACKGROUND OF THE INVENTION

Wind-powered recreational conveyances are gaining in popularity. Wind has powered conveyances of myriad types since ancient times. Similarly, kites and kite-like devices have been known for many centuries. However, kites have always been controllable only through manipulation by a ground-based operator. What is proposed is an alternative to the traditional kite which can carry one or more occupants who can control altitude, pitch and yaw from their position within the kite itself.

### BRIEF SUMMARY OF THE INVENTION

The proposed device consists of a pilotable aircraft-like envelope, tethered to a stationary object or moving vehicle, the tether length controllable by the occupant.

### DESCRIPTION OF DRAWINGS

1. Four examples of possible fanciful shapes the proposed device may take
2. Enlargement of a possible fanciful shape of the proposed device showing approximate location of the cockpit
3. Front view of a possible shape of the proposed device showing orientation of tether
4. Bottom view of possible shape of the proposed device showing orientation of tether
5. Detail of pitch control mechanism mounted in cockpit
6. Alternative pitch control mechanism mounted behind cockpit
7. Detail of alternative pitch control mechanism located aft of cockpit
8. Side view of ram air tube and outlet which controls yaw of the proposed device
9. Detail showing control method for ram air yaw control
10. Detail, top view of aft end of ram air yaw control mechanism

### DETAILED DESCRIPTION OF THE INVENTION

The proposed device consists of an envelope of any fanciful winged shape, i.e. stealth fighter, animal, butterfly, which can be formed of either an inflatable material forming the structure or a lightweight rigid material or a combination of the two. This material must lend the device a structure sufficiently rigid to accommodate one or more passengers, but provide the structure with a modicum of resiliency sufficient to prevent damage during contact with the ground.

In a kite-like manner, the device is tethered to the ground. However, the tether length is controlled by the passenger(s) through remote control of a ground-based winch which allows the tether to unwind (thereby lengthening said tether) or wind up (thereby shortening said tether). This remote controller may take the form of any handheld remote control such as for a television or garage door opener. The winch can be mounted to a solid structure on the ground such as a tree or post so that the device may be used when atmospheric conditions provide enough lift to operate the device stationary. Alternatively, the winch may be mounted on a boat or land vehicle so that the device may be used when forward motion is required to provide lift. Lift is provided by the device's wings in either case. It is contemplated that a small lift component may be achieved through the filling of the envelope with a light-weight gas such as helium, but the device is not necessarily sustained in lift by such assistance.

The occupant(s) can also control pitch through the device's tether. The point at which the tether is joined to the device can be moved in a fore or aft direction, thereby moving the force exerted by the tether on the device. Two different methods are possible to vary pitch through fore/aft tether movement. First, the tether can be attached through a loop of cable which is also attached to the bottom end of a control stick resembling an aircraft control stick. Forward movement of the stick by the pilot results in forward movement of the tether and rearward movement results in rearward displacement of the tether. When the design of the device prevents placement of the occupant(s) directly above the tether attach point, the pilot may move a control stick the bottom of which is connected to a pushrod. The pushrod connects the stick to a transversely-mounted axle that moves forward or aft in a set of tracks. To this axle is connected the tether which, in turn, moves fore and aft with control stick movement by the pilot.

Yaw can also be controlled to a certain extent by the pilot. As an alternative or in addition to the conventional aircraft-like rudder, this device is yawed by lateral expulsion of ram air at the tail end of the device. Incident airflow enters an open longitudinally situated tube at the front of the device and travels down this tube rearward. As the ram air approaches the rear of the device it is accelerated by the ever-decreasing diameter of the tube. The aft end of the tube is closed. However, the accelerated ram air escapes through holes in the side of the tube. There are two such holes, one on each side of the tube near the aft end. Inside of the tube at the aft end is a rudder-like device which, when in neutral position is parallel with the flow of ram air allowing the ram air to escape through both side holes, effecting no yaw. From the cockpit, this rudder can be turned about a vertical axis so that it directs the ram air out of either one of the side holes near the aft end of the tube while sealing off egress from the other hole. In the manner of newer helicopters which use thrust from engine exhaust rather than a tail rotor to effect anti-torque yaw, this device is yawed by an acceleration of air to one side at the aft end of the craft.

The cockpit of the device may be open or closed, as design dictates. Presence of landing gear is optional, as the device is usable on land or water, but sufficient flotation ability is required if the particular design is to be used on water.

1. A piloted kite capable of carrying one or more occupants during tethered, unpowered, controlled flight

2. The kite according to claim #1 which achieves lift through movement through the air while tethered to a moving vehicle.

3. The kite according to claim #1 which achieves lift, alternatively to the method in claim #2, through being tethered stationary in wind sufficient to provide lift.

4. The kite according to claim #1 in which the structure is composed of a light-weight, sealed envelope capable of being inflated to greater than atmospheric pressure and, when so inflated, lends the kite structural rigidity sufficient to sustain controlled, tethered flight with said occupant(s) aboard.

5. The kite according to claim #1 in which yaw control is achieved with a conventional vertical airfoil-shaped rudder, either fore or aft mounted.

6. The kite according to claim #1 in which yaw control is achieved, either in addition to the method described in claim #5 or as an alternative thereto, through incoming ram air entering a tube at the front of the kite, passing through the length of said tube and exiting the tube at the rear of the kite.

7. Said tube according to claim #6 is open at the front of the kite in a manner which allows ram air to enter from the direction parallel to said tube. Said tube, being closed at the end at the rear of the kite, features two holes near the end at the rear of the kite on opposite sides of said tube, centered at 180 degrees apart on circumference of said tube and oriented such that ram air escapes in a direction perpendicular to its incoming path.

8. Said tube according to claim #7 which contains a rudder-like or valve-like control surface within, operable by the aircraft's occupant(s), in which said ram air is diverted toward only one or the other of the outlet holes at the rear of the kite when this rudder is fully deflected to one or the other side by the occupant(s) in order to effect yaw of the kite. Said rudder- or valve-like control surface consists of a flat, ovoid surface with an axle vertically through its middle. Said axle ends are mounted 180 degrees apart in the ram air tube, top and bottom, but 90 degrees from the centers of said exit holes.

9. The control surface according to claim #8 which pivots about said axis via two externally mounted control horns, full deflection of which allows said ram air to exit only one of the tube's exit holes at a time, thereby effecting thrust to one side sufficient to yaw the kite. Said external control horns are connected via cable to a pair of rudder pedal-like devices controllable by the kite's occupant(s), as in a conventional aircraft.

10. Said tube according to claim #7 is tapered, being larger in inlet diameter at the front end of the kite than at the rear (exit) end in order to facilitate acceleration of the ram air.

11. The kite according to claim #1 in which pitch control is effected by the occupant(s) through fore/aft movement of the tether's connection to the kite.

12. The pitch control according to claim #11 in which a control stick is manipulated by the occupant in a forward/backward direction. Occupant grasps and moves the upper portion of the control stick, the middle pivots on its mount situated inside the control box housing said mechanism. The bottom of the control stick is fastened by various possible means to two cables each at a 90 degree angle to said stick and 180 degrees to one another, one fore and one aft. Each of said cables runs through a stationary pulley, one on the forward inside wall of said control box, one on the rear inside wall of said control box. The ends of the two cables are attached at a single point, to which is also attached the kite's tether. Forward movement of the control stick effects forward displacement of the kite's tether, thereby lowering the kite's forward end during flight. Contrarywise, aft control stick movement by the pilot effects aft displacement of the kite's tether, thereby raising the kite's front in flight.

13. As an alternative to the pitch mechanism of claim #11, the control stick can be attached at a 90 degree angle to a pushrod running aft from the cockpit. The aft end of said pushrod is attached to an axle with a wheel at each end. The wheels run for and aft in tracks with the movement of the control stick by the pilot. To this axle is attached the kite's tether, such that fore/aft movement of the control stick displaces the kite's tether to effect pitch with the same results as the mechanism in claims #11 and 12.

14. The kite according to claim #1 in which altitude is controlled by the occupant(s) either through pitch control in claims #11-13 and/or through lengthening/shortening of the kite's tether. This is achieved through the grounded end of the tether being attached to an electrically-powered winch, which through remote control by the kite's occupant(s), can lengthen/shorten the tether.

15. The kite according to claim #1 in which the structure is composed either in conjunction with such structure according to claim #4 or, alternatively of a rigid light-weight material such as, but not limited to carbon fiber.

16. The kite according to claim #1 designed to resemble any of various fanciful abstract shapes, aircraft or animals.
